(19) United States
(12) Patent Application Publication
(10) Pub. No.: US 2006/0205627 A1
(43) Pub. Date: Sep. 14, 2006

(54) Liquid bleaching composition

(75) Inventors: Maartje Ouwendijk-Vrijenhoek, Vlaardingen (NL); Derdiyok Sonmezer, Vlaardingen (NL); Simon Marinus Veerman, Vlaardingen (NL)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Conopco Inc, d/b/a UNILEVER

(21) Appl. No.: 11/371,716

(22) Filed: Mar. 9, 2006

(30) Foreign Application Priority Data
Mar. 11, 2005 (EP) EP05075594

(51) Int. Cl. C11D 3/00

(52) U.S. Cl. 510/376

(57) ABSTRACT

The present invention provides an aqueous liquid bleaching detergent composition, comprising: (e) a bleach catalyst; and (f) from 0.001 to 0.1% by weight of an anti-oxidant, said composition being substantially free of boron. It was found that said composition shows favourable storage properties: its bleaching and cleaning activities are maintained after prolonged periods of storage.

### FIELD OF THE INVENTION

The present invention relates to liquid detergent compositions containing a bleach catalyst, wherein the activity of the bleach catalyst is stabilised against deterioration (e.g. by degradation) during storage.

### BACKGROUND OF THE INVENTION

The use of bleaching catalysts for stain removal has been developed over recent years. The recent discovery that some catalysts are capable of bleaching effectively in the absence of an added peroxyl source has recently become the focus of some interest, as will be clear from e.g. WO-99/65905, WO-00/12667, WO-00/12808, WO-00/29537, and WO-00/60045.

The shelf life of a product may be regarded as the period of time over which the product may be stored whilst retaining its required quality. A satisfactory shelf life is in many instances a crucial factor for the success of a commercial product. A product with a short shelf life generally dictates that the product is made in small batches and is rapidly sold to the customer. It is also a concern to the owners of a brand with a short shelf life that the consumer uses the product within the shelf life; otherwise the consumer may be inclined to change to a similar product of another brand. In contrast, a similar product with a long shelf life may be made in larger batches, held as stock for a longer period of time and the period of time that a consumer stores the product is not of a great concern to the owners of the particular brand concerned. Despite the shelf life being an important consideration, the product must also be active during use.

It is an object of the present invention to provide a liquid bleaching composition that has favourable storage properties whilst being active in use.

It is another object of the invention to provide a liquid bleaching composition that is chemically and physically stable when in storage, and shows good bleaching and cleaning performance when in use.

We have now surprisingly found that it is possible to enhance the stability of a bleach catalyst in aqueous liquid detergent compositions by formulating them in a certain way, whereby boron-containing compounds, such as borates, are not employed in said compositions.

### DEFINITION OF THE INVENTION

Accordingly, in one aspect the present invention provides an aqueous liquid bleaching detergent composition, comprising:
(a) a bleach catalyst being an organic substance which forms a complex with a transition metal for bleaching a substrate with atmospheric oxygen, the liquid bleaching composition upon addition to an aqueous medium providing a diluted bleaching medium substantially devoid of a peroxygen bleach or a peroxy-based or peroxyl-generating bleach system; and
(b) from 0.001 to 0.1% by weight of an anti-oxidant; said composition being substantially free of boron and of perfume.

Furthermore, in a second aspect the invention provides a method of bleaching a textile with a liquid bleaching composition of the invention in an aqueous environment, rinsing the textile and drying it.

### DETAILED DESCRIPTION OF THE INVENTION

It has been found that the aqueous liquid bleaching detergent composition of the invention shows favourable storage properties: its bleaching and cleaning activities were maintained after prolonged periods of storage.

In addition, the liquid bleaching composition of the invention is environmentally friendly because it is substantially free of any boron-containing compounds. In this connection, “substantially free of boron” is intended to mean that at most 0.05% by weight of boron is present in said liquid composition.

On the other hand, the storage stability of the bleach catalyst in the liquid detergent composition of the invention was found to be improved because said composition is substantially free of perfume, which is intended to mean that less than 0.001% by weight of perfume is present in said liquid composition.

Preferably, the aqueous liquid bleaching composition of the invention has a water content of 30 to 80% by weight, more preferably 45 to 80% by weight.

The liquid bleaching composition of the invention may be generally either isotropic or structured. Preferably, said liquid composition is isotropic.

The liquid bleaching composition may be formulated as a concentrated liquid for direct application to a substrate, or for application to a substrate following dilution, such as dilution before or during use of the liquid composition by the consumer or in washing apparatus.

Preferably, the liquid bleaching composition of the invention is used for cleaning and bleaching a laundry fabric.

Product Form

It should be understood that the liquid compositions according to any aspect of the present invention have a physical form which preferably ranges from a pourable liquid, a pourable gel to a non-pourable gel. These forms are conveniently characterised by the product viscosity. In these definitions, and unless indicated explicitly to the contrary, throughout this specification, all stated viscosity's are those measured at a shear rate of 21 s⁻¹ and at a temperature of 25° C.

Pourable liquid compositions according to any aspect of the present invention preferably have a viscosity of no more than 1,500 mPa·s, more preferably no more than 1,000 mPa·s, still more preferably, no more than 500 mPa·s. Compositions according to any aspect of the present invention which are pourable gels, preferably have a viscosity of at least 1,500 mPa·s but no more than 6,000 mPa·s, more preferably no more than 4,000 mPa·s, still more preferably no more than 3,000 mPa·s and especially no-more than 2,000 mPa·s.

Compositions according to any aspect of the present invention which are non-pourable gels, preferably have a viscosity of at least 6,000 mPa·s but no more than 12,000 mPa·s,.more preferably no more than 10,000 mPa·s, still more preferably no more than 8,000 mPa·s and especially no more than 7,000 mPa·s.

Liquid detergent compositions according to the invention may be suitably contained in water-soluble packages which are preferably made from polyvinyl alcohol (PVOH) film. If so, then the perfume components may be effectively segregated from the liquid detergent composition of the invention by including them in the film material of the water soluble package.

Alternatively, a water soluble package may be applied wherein the film encloses at least two containers of which the contents are segregated from each other during storage and wherein the perfume components not contained in the liquid detergent composition of the invention are present in a container which is different and segregated from the container holding the composition of the invention.

Physically Stable

For the purpose of this invention a composition is physically stable when less than 2% phase separation occurs after 2 week storage at 37° C. With isotropic liquids this phase separation generally starts with the liquid becoming hazy.

pH-Value

The pH-value of the composition of the invention is preferably less than or equal to 7, more preferably in the range of from 6 to 7, still more preferably from 6.5 to 7. At this range of pH-values a chemically stable composition will be obtained.

However, because the composition of the invention is substantially free of boron, it was found that acceptable bleach catalyst stabilities could also be obtained at higher. pH-values up to a pH-of around 8.

On the other hand, when protease enzyme is present in the composition of the invention, said relatively low pH-value range of from 6 to 7 may also be beneficial for maintaining the activity of the protease enzyme, depending on the type thereof.

However, for obtaining favourable bleaching and cleaning performance when the composition of the invention is used for treating textile, it is preferred that the pH-value of said composition is raised to or fixed at a value in the range of from 7.5 to 9 upon dilution with water. Hence, if the pH-value of the liquid composition of the invention is less than or equal to 7, it is preferred that said composition additionally contains a pH-changing means capable of bringing about this increase of pH-value. Desirably, the pH-changing means is capable of raising the pH-value to at least 8 upon dilution with water.

The pH-changing means is effectively provided by a pH-jump system. Suitable types of pH-jump systems are based on the principle of insoluble alkaline salts in the undiluted composition that dissolve on dilution to raise the solution pH. Examples of such alkaline salts are sodium tripolyphosphate (STP), sodium carbonate, sodium bicarbonate, sodium silicate, sodium pyro- and ortho-phosphate.

An alternative type of pH-jump system for use in a liquid detergent composition includes a metal cation and an N-containing compound, as disclosed in U.S. Pat. No. 5,484,555.

The Antioxidant

The liquid detergent composition of the invention comprises 0.001 to 0.1% by weight of an antioxidant so as to further increase the storage stability of said liquid composition. Preferably, the antioxidant is present at a concentration in the range 0.002 to 0.08% by weight.

Anti-oxidants are substances as described in Kirk-Othmers (Vol 3, pg 424) and in Uhlmans Encyclopedia (Vol 3, pg 91).

One class of anti-oxidants which may be used in the present invention is alkylated phenols, having the general formula: 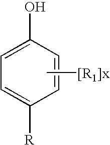
wherein R is C₁-C₂₂ linear or branched alkyl, preferably methyl or branched C₃-C₆ alkyl; C₃-C₆ alkoxy, preferably methoxy; R₁ is a C₃-C₆ branched alkyl, preferably tert-butyl; x is 1 or 2. Hindered phenolic compounds are a preferred type of alkylated phenols having this formula. A preferred hindered phenolic compound of this type is 2,6-di-tert-butyl-hydroxy-toluene (BHT).

Furthermore, a preferred anti-oxidant for use in the composition of the present invention is selected from the group consisting of α-tocopherol, ethoxyquine, 2,2,4-trimethyl-1,2-dihydroquinoline, 2,6-di-tert-butyl-hydroquinone, tert-butyl-hydroxy anisole, lignosulphonic acid and salts thereof, and mixtures thereof. It is noted that ethoxyquine (1,2-dihydro-6-ethoxy-2,2,4-trimethylchinolin) is marketed under the name Raluquin™ by the company Rashig™.

Other preferred types of antioxidant for use in the present invention are 6-hydroxy-2,5,7,8-tetra-methylchroman-2-carboxylic acid (Trolox™) and 1,2-benzisothiazoline-3-one (Proxel GXL™)

A further class of anti-oxidants which may be suitable for use in the present invention is a benzofuran or benzopyran derivative having the formula: 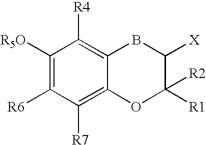
wherein R₁ and R₂ are each independently alkyl or R₁ and R₂ can be taken together to form a C₅-C₆ cyclic hydrocarbyl moiety; B is absent or CH₂; R₄ is C₁-C₆ alkyl; R₅ is hydrogen or —C (O) R₃ wherein R₃ is hydrogen or C₁-C₁₉ alkyl; R₆ is C₁-C₆ alkyl; R₇ is hydrogen or C₁-C₆ alkyl; X is —CH₂OH, or —CH₂A wherein A is a nitrogen comprising unit, phenyl, or substituted phenyl. Preferred nitrogen comprising A units include amino, pyrrolidino, piperidino, morpholino, piperazino, and mixtures thereof.

Anti-oxidants such as tocopherol sorbate, butylated hydroxy benzoic acids and their salts, gallic acid and its alkyl esters, uric acid and its salts and alkyl esters, sorbic acid and its salts, and dihydroxy fumaric acid and its salts may also be used. The most preferred types of anti-oxidant for use in the present invention are 2,6-di-tert-butyl-hydroxy-toluene (BHT), alpha-tocopherol, 1,2-benzisothiazoline-3-one (Proxel GXL™) and mixtures thereof.

The Bleach Catalyst

The bleach catalyst present in the liquid composition of the invention is an organic substance which forms a complex with a transition metal for bleaching a substrate with atmospheric oxygen, whereby the liquid bleaching composition of the invention upon addition to an aqueous medium (such as water) provides a diluted bleaching medium substantially devoid of a peroxygen bleach or a peroxy-based or peroxyl-generating bleach system.

In typical washing compositions the level of the organic substance is such that the in-use level is from 0.05 μM to 50 mM, with preferred in-use levels for domestic laundry operations falling in the range 1 to 100 μM. Higher levels may be desired and applied in industrial textile bleaching processes. A mixture of different catalysts may be employed in the bleaching composition.

Suitable organic molecules (ligands) for forming complexes and complexes thereof are found, for example in: GB 9906474.3; GB 9907714.1; GB 98309168.7, GB 98309169.5; GB 9027415.0 and GB 9907713.3; DE 19755493; EP-A-999,050; WO-A-95/34628; EP-A-458,379; EP-A-909809; U.S. Pat. No. 4,728,455; WO-A-98/39098; WO-A-98/39406, WO-A-97/48787, WO-A-00/29537; WO-A-00/52124, and WO-A-00/60045 the complexes and organic molecule (ligand) precursors of which are herein incorporated by reference. An example of a preferred catalyst is a transition metal complex of MeN4Py ligand (N,N-bis(pyridin-2-yl-methyl)-1,1-bis(pyridin-2-yl)-1-aminoethane)

The ligand forms a complex with one or more transition metals, in the latter case for example as a dinuclear complex. Suitable transition metals include for example: manganese in oxidation states II-V, iron II-V, copper I-III, cobalt I-III, titanium II-IV, tungsten IV-VI, vanadium II-V and molybdenum II-VI.

An example of a preferred catalyst is a monomer ligand or transition metal catalyst thereof of a ligand having the formula (I): 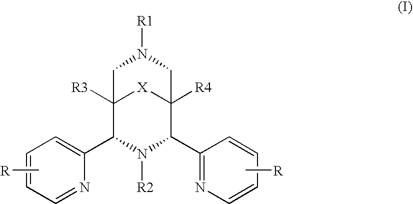
wherein each R is independently selected from: hydrogen, F, Cl, Br, hydroxyl, C₁-C₄-alkylO—, —NH—CO—H, —NH—CO—C₁-C₄-alkyl, —NH₂, —NH—Cl—C₄-alkyl, and C₁-C₄-alkyl;

R1 and R2 are independently selected from:

C₁-C₄-alkyl, C₆-C₁₀-aryl, and a group containing a heteroatom capable of coordinating to a transition metal, wherein at least one of R1 and R2 is the group containing the heteroatom;

R3 and R4 are independently selected from hydrogen, C₁-C₈ alkyl, Cl-C₈-alkyl-O—C₁-C₈-alkyl, C₁-C₈-alkyl-O—C₆-C₁₀-aryl, C₆-C₁₀-aryl, C₁-C₈-hydroxyalkyl, and —(CH₂)ₙC(O)OR5

wherein R5 is independently selected from: hydrogen, C₁-C₄-alkyl, n is from 0 to 4, and mixtures thereof; and,

X is selected from C═O, —[C(R6)₂]_{y} wherein Y is from 0 to 3 each R6 is independently selected from hydrogen, hydroxyl, C₁-C₄-alkoxy and C₁-C₄-alkyl.

With regard to the above formula (I) it is also particularly preferred that R1 and R2 may also be independently selected from: C₁ to C₂₂-optionally substituted alkyl, and an optionally substituted tertiary amine of the form —C₂-C₄-alkyl-NR7R8, in which R7 and R8 are independently selected from the group consisting of straight chain, branched or cyclo C₁-C₁₂ alkyl, benzyl, the —C₂-C₄-alkyl- of the —C₂-C₄-alkyl-NR7R8 may be substituted by 1 to 4 C₁-C₂-alkyl, or may form part of a C₃ to C6 alkyl ring, and in which R7 and R8 may together form a saturated ring containing one or more other heteroatoms.

Another preferred class of ligands are macropolycyclic rigid ligands of the formula: 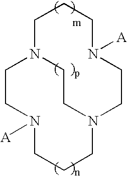
wherein m and n are 0 or integers from 1 to 2, p is an integer from 1 to 6, preferably m and n are both 0 or both 1 (preferably both 1 ), or m is 0 and n is at least 1; and p is 1; and A is a nonhydrogen moiety preferably having no aromatic content; more particularly each A can vary independently and is preferably selected from methyl, ethyl, propyl, isopropyl, butyl, isobutyl, tert-butyl, C₅-C₂₀ alkyl, and one, but not both, of the A moieties is benzyl, and combinations thereof.

Preferably, the macropolycyclic ligand is of the formula: 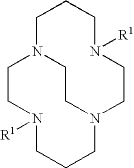
wherein “R¹” is independently selected from H, and linear or branched, substituted or unsubstituted C1-C20 alkyl, alkylaryl, alkenyl or alkynyl; and all nitrogen atoms in the macropolycyclic rings are coordinated with the transition metal.

Of the macropolycyclic ligands 5,12-dimethyl-1,5,8,12-tetraazabicyclo[6.6.2]hexadecane is preferred. This ligand is most preferred as its manganese complex [Mn(Bcyclam)Cl₂] and may be synthesised according to WO-A-98/39098.

The transition metal complex preferably is of the general formula (AI):
[MₐLₖXₙ] Yₘ
in which:

M represents a metal selected from Mn(II)-(III)-(IV)-(V), Cu(I)-(II)-(III), Fe (II)-(III)-(IV)-(V), Co(I)-(II)-(III), Ti(II)-(III)-(IV), V(II)-(III)-(IV)-(V), Mo(II)-(III)--(IV)-(V)-(VI) and W(IV)-(V)-(VI), preferably from Fe(II)-(III)-(IV)-(V);

L represents the ligand, preferably N,N-bis(pyridin-2-yl-methyl)-1,1-bis(pyridin-2-yl)-1-aminoethane, or its protonated or deprotonated analogue;

X represents-a-coordinating species selected from any mono, bi or tri charged anions and any neutral molecules able to coordinate the metal in a mono, bi or tridentate manner;

Y represents any non-coordinated counter ion;

a represents an integer from 1 to 10;

k represents an integer from 1 to 10;

30 n represents zero or an integer from 1 to 10;

m represents zero or an integer from 1 to 20.

Fatty Acid Soap

In order to further increase the storage stability of the liquid bleaching detergent composition of the invention, said composition preferably comprises a fatty acid soap of increased saturation. The extent of saturation of the fatty acid is expressed in terms of iodine value: the lower the iodine value, the higher the degree of saturation. Desirably, the fatty acid soap has a iodine value lower than 1.0, more preferably lower than 0.3.

In this connection, the iodine value of the fatty acid soap is defined as the weight of halogens expressed as iodine absorbed by 100 parts by weight of fatty acid soap. It follows that a lower iodine value will be measured if the level of saturation of the fatty acid soap will be higher.

The iodine value is determined by the Wijs' method described by IFFO (ISO 3961:1996, May 1998) in which the test sample is dissolved in a solvent and Wijs' reagent added. After about one hour reaction time, potassium iodide and water are added to the mixture. Iodine liberated by the process is titrated with sodium thiosulphate solution.

Preferably, the fatty acid soap has a degree of saturation of more than 95%, said degree of saturation being most preferably 100%. Reason is that such saturated fatty acid soaps have been found to perform favourably for improving storage stability of the bleach catalyst present in the liquid detergent composition of the invention.

Good results with respect to this storage stability were obtained when the fatty acid contained in the soap is a mixture f lauric acid, myristic acid, palmitic acid, stearic acid, arachidic acid, and behenic acid.

It will be recognised that the fatty acid soaps optionally used in the composition of the invention, consist of a fatty acid and a cation. Suitable cations include, sodium, potassium, ammonium, monoethanol ammonium diethanol ammonium, triethanol ammonium, tetraalkyl ammonium, e.g., tetra methyl ammonium up to tetradecyl ammonium etc. cations.

Preferably, the level of the fatty acid soap in the liquid composition of the invention is in the range of from 0.2 to 8%, more preferably from 0.5 to 4%, by weight based on the full liquid composition of the invention.

Enzymes

Detersive enzyme”, as used herein, means any enzyme having a cleaning, stain removing or otherwise beneficial effect in a laundry application. Enzymes are preferably included in the liquid detergent composition of the present invention for a variety of purposes, including removal of protein-based, saccharide-based, or triglyceride-based stains, for the prevention of refugee dye transfer, and for fabric restoration. The composition of the invention preferably contains an enzyme selected from the group consisting of a protease, an amylase, a lipase, a cellulase and mixtures thereof. Preferably, said composition contains a protease enzyme and/or an amylase. Other enzymes which are usually present in liquid detergent compositions, include peroxidases of any suitable origin, such as vegetable, animal, bacterial, fungal and yeast origin. Preferred selections are influenced by factors such as pH-activity and/or stability optima, thermo-stability, and stability to active detergents, builders and the like. In this respect bacterial or fungal enzymes are preferred, such as bacterial amylases and proteases, and fungal cellulases.

Enzymes are normally incorporated into detergent compositions at levels sufficient to provide a “cleaning-effective amount”. The term “cleaning effective amount” refers to any amount capable of producing a cleaning, stain removal, soil removal, 5 whitening, deodorizing, or freshness improving effect on substrates such as fabrics. In practical terms for current commercial preparations, typical amounts are up to about 5 mg by weight, more typically 0.001 mg to 3 mg, of active enzyme per gram of the detergent composition. Stated otherwise, the 10 compositions herein will typically comprise from 0.0001% to 10%, preferably from 0.001% to 5%, more preferably 0.005%-l% by weight of a commercial enzyme preparation.

The Proteolytic Enzyme

Endopeptidases (proteolytic enzymes or proteases) of various qualities and origins and having activity in various pH ranges of from 4-12 are available and can be used in the instant invention. Examples of suitable proteolytic enzymes are the subtilisins, which can be obtained from particular strains of B. subtilis, B. lentus, B. amyloliquefaciens and B. licheniformis, such as the commercially available subtilisins Savinase™, Alcalase™, Relase™, Kannase™ and Everlase™ as supplied by Novo Industri A/S, Copenhagen, Denmark or Purafect™, PurafectOxP™ and Properase™ as supplied by Genencor 25-International. Chemically or genetically modified variants of these enzymes are included such as described in WO-A-99/02632 pages 12 to 16 and in WO-A-99/20727 and also variants with reduced allergenicity as described in WO-A-99/00489 and WO-A-99/49056.

Preferably, the protease is present in the liquid detergent composition of the invention in a dissolved or dispersed form, i.e., the protease is not encapsulated to prevent the protease from the liquid composition. Instead the protease is desirably more or less in direct contact with the liquid composition. Suitable examples of proteases are the subtilisins which are obtained from particular strains of B. subtilis and B. licheniformis. One suitable protease is obtained from a strain of Bacillus, having maximum activity throughout the pH range of 8-12, developed and sold as ESPERASE™ by Novo Industries A/S of Denmark, hereinafter “Novo”. The preparation of this enzyme and analogous enzymes is described in GB 1,243,784 to Novo. Other suitable proteases include ALCALASE™ and SAVINASE™ from Novo and MAXATASE™ from International Bio-Synthetics, Inc., The Netherlands; as well as Protease A as disclosed in EP 130,756 A, and Protease B as disclosed in EP 303,761 A and EP 130,756 A. See also a high pH protease from Bacillus sp. NCIMB 40338 described in WO 9318140 A to Novo. Enzymatic detergents comprising protease, one or more other enzymes, and a reversible protease inhibitor are described in WO 9203529 A. Other preferred proteases include those of WO 9510591 A. When desired, a protease having decreased adsorption and increased hydrolysis is available as described in WO 9507791. A recombinant trypsin-like protease for detergents suitable herein is described in WO 9425583.

Useful proteases are also described in PCT publications: WO 95/30010, WO 95/30011, WO 95/29979.

Preferred proteolytic enzymes are also modified bacterial serine proteases, such as those described in EP-A-251446 (particularly pages 17, 24 and 98), and which is called herein “Protease B”, and in EP-A-199404, which refers to a modified bacterial serine proteolytic enzyme which is called “Protease ” herein, Protease A as disclosed in EP-A-130756.

The preferred liquid laundry detergent compositions according to the present invention comprise at least 0.001% by weight, of a protease enzyme. However, an effective amount of protease enzyme is sufficient for use in the liquid laundry detergent compositions described herein. The term “an effective amount” refers to any amount capable of producing a cleaning, stain removal, soil removal, whitening, deodorizing, or freshness improving effect on substrates such as fabrics. In practical terms for current commercial preparations, typical amounts are up to about 5 mg by weight, more typically 0.001 mg to 3 mg, of active enzyme per gram of the detergent composition. Stated otherwise, the compositions herein will typically comprise from 0.001% to 5%, preferably 0.01%-1% by weight of a commercial enzyme preparation. Typically, the proteolytic enzyme content is up to 0.2%, preferably from 4×10⁻⁵% to 0.06% by weight of the composition of pure enzyme.

Lipolytic Enzyme

As outlined above, the present invention may also provide the use of a lipase enzyme in combination with a liquid detergent composition of the present invention as specified in claim 1. Said lipase enzyme may be present in said liquid detergent composition at a level of 10-20,000 LU per gram. The lipase 25 enzyme is preferably selected from the group consisting of Lipolase, Lipolase ultra, LipoPrime, Lipomax, Liposam, and lipase from Rhizomucor miehei (e.g. as described in EP-A-238 023 (Novo Nordisk).

A characteristic feature of lipases is that they exhibit interfacial activation. This means that the enzyme activity is much higher on a substrate which has formed interfaces or micelles, than on fully dissolved substrate. Interface activation is reflected in a sudden increase in lipolytic activity when the substrate concentration is raised above the critical micel concentration (CMC) of the substrate, and interfaces are formed. Experimentally this phenomenon can be observed as a discontinuity in the graph of enzyme activity versus substrate concentration. Contrary to lipases, however, cutinases do not exhibit any substantial interfacial activation.

Suitable lipase enzymes for detergent usage include those produced by microorganisms of the Pseudomonas group, such as Pseudomonas stutzeri ATCC 19.154, as disclosed in GB 1,372,034. See also lipases in Japanese Patent Application 53,20487. This lipase is available from Amano Pharmaceutical Co. Ltd., Nagoya, Japan, under the trade name Lipase P “Amano,” or “Amano-P.” Other suitable commercial lipases include Amano-CES, lipases ex Chromobacter viscosum, e.g. Chromobacter viscosum var. lipolyticum NRRLB 3673 from Toyo Jozo Co., Tagata; Japan; Chromobacter viscosum lipases from U.S. Biochemical Corp., U.S.A. and Disoynth Co., The Netherlands, and lipases ex Pseudomonas gladioli.LIPOLASE™ enzyme derived from Humicola lanyginosa and commercially available from Novo, see also EP 341,947, is a preferred lipase for use herein. Lipase and amylase variants stabilized against peroxidase enzymes are described in WO 9414951 A to Novo. See also WO-9205249. Cutinase enzymes suitable for use herein are described in WO 8809367 A to Genencor.

The lipolytic enzyme suitable for use in the present invention can usefully be added to the detergent composition in any suitable form, i.e. the form of a granular composition, a slurry of the enzyme, or with carrier material (e.g. as in EP-A-258 068 and the, Savinase (™) and Lipolase (™) products of Novozymes). A good way of adding the enzyme to a liquid detergent product is in the form of a slurry containing 0.5 to 50% by weight of the enzyme in a ethoxylated alcohol nonionic surfactant, such as described in EP-A-450 702 (Unilever).

Amylolytic Enzymes

The present invention may also provide the use of an amylase enzyme in a liquid detergent formulation of the invention. Suitable amylases include those of bacterial or fungal origin. Chemically or genetically modified variants of these enzymes are included as described in WO-A-99/02632 pages 18,19. Commercial cellulase are sold under the tradename Purastar™, Purastar OxA™ (formerly Purafact Ox Am™) by Genencor; Termamyl™, Fungamyl™, Duramyl™, Natalase™, all available from Novozymes.

Amylases suitable herein include, for example, alfa-amylases described in GB 1,296,839 to Novo; RAPIDASE™, International Bio-Synthetics, Inc. and TERMAMYL™, Novo. FUNGAMYL™ from Novo is especially useful.

See, for example, references disclosed in WO 9402597. Stability-enhanced amylases can be obtained from Novo or from Genencor International. One class of highly preferred amylases herein have the commonality of being derived using site-directed mutagenesis from one or more of the Baccillus amylases, especially the Bacillus cc-amylases, regardless of whether one, two or multiple amylase strains are the immediate precursors.

Oxidative stability-enhanced amylases vs. the above-identified reference amylase are preferred for use, especially in bleaching, more preferably oxygen bleaching, as distinct from chlorine bleaching, detergent compositions herein. Such preferred amylases include (a) an amylase according to WO 9402597, known as TERMAMYL™,

Particularly preferred amylases herein include amylase variants having additional modification in the immediate parent as described in WO 9510603 A and are available from the assignee, Novo, as. DURAMYL™. Other particularly preferred oxidative stability enhanced amylase include those described in WO 9418314 to Genencor International and WO 9402597 to Novo Or WO 9509909 A to Novo.

Detergent enzymes are usually incorporated in an amount of 0.00001% to 2%, and more preferably 0.001% to 0.5%, and even more preferably 0.005% to 0.2% in terms of pure enzyme protein by weight of the composition. Detergent enzymes are commonly. employed in the form of granules made of crude enzyme alone or in combination with other components in the detergent composition. Granules of crude enzyme are used in such an amount that the pure enzyme is 0.001 to 50 weight percent in the granules. The granules are used in an amount of 0.002 to.20 and preferably 0.1 to 3 weight percent. Granular forms of detergent enzymes are known as Enzoguard™ granules, prills, marumes or T-granules. Other suitable forms of enzymes are liquid forms such as the “L” type liquids from Novo Nordisk, slurries of enzymes in nonionic surfactants such as the “SL” type sold by Novo Nordisk and microencapsulated enzymes marketed by Novo Nordisk under the tradename “LDP” and “CC”.

The enzymes can be added as separate single ingredients (prills, granulates, stabilised liquids, etc. containing one enzyme) or as mixtures of two or more enzymes (e.g. cogranulates). Enzymes in liquid detergents can be stabilised by various techniques as for example disclosed in U.S. Pat. No. 4,261,868 and U.S. Pat. No. 4 318 818.

Surfactant

The liquid composition of the invention may comprise from 1 to 90%, preferably from 10 to 70% by weight of a surfactant, preferably selected from anionic, nonionic, cationic, zwitterionic active detergent materials or mixtures thereof. Preferably, the compositions herein comprise 12 to 60% by weight of surfactant, more preferably 15 to 40% by weight.

The compositions of the invention are preferably substantially free of aklylbenzene sulphonate surfactant, but may contain small amounts of eg. C₁₁-C₁₈ alkylbenzene sulphonates, eg up to 5% by weight or up to 1% by weight.

Non-limiting examples of surfactants useful herein typically at levels from about 10% to about 70%, by weight, include the C₁₀-C₁₈ secondary (2,3) alkyl sulphates of the formula CH₃(CH₂)ₓ(CHOS0₃-M+)CH₃ and CH₃(CH₂)_{y}(CHOS0₃-M+)CH₂CH₃ where x and (y+1) are integers of at least about 7, preferably at least about 9, and M is a water-solubilising cation, especially sodium, unsaturated sulphates such as oleyl sulphate, C₁₀-C₁₈ alkyl alkoxy carboxylates (especially the EO 1-7 ethoxycarboxylates), the C₁₀-C₁₈ glycerol ethers, the C₁₀-C₁₈ alkyl polyglycosides and their corresponding sulphated polyglycosides, and C₁₂-C₁₈ alpha-sulphonated fatty acid esters. If desired, the conventional nonionic and amphoteric surfactants such as the C₁₂-C₁₈ alkyl ethoxylates (“AE”) including the so-called narrow peaked alkyl ethoxylates and C₆-C₁₂ alkyl phenol alkoxylates (especially ethoxylates and mixed ethoxy/propoxy), C₁₂-C₁₈ betaines and sulphobetaines (“sultaines”), C₁₀-C₁₈ amine oxides, and the like, can also be included in the overall compositions. The C₁₀-C₁₈ N-alkyl polyhydroxy fatty acid amides can also be used. Typical examples include the C₁₂-C₁₈ N-methylglucamides. See WO-92/06,154. Other sugar-derived surfactants include the N-alkoxy polyhydroxy fatty acid amides, such as C₁₀-C₁₈ N-(3-methoxypropyl) glucamide. C₁₀-C₂₀ conventional soaps may also be used. If high sudsing is desired, the branched-chain C₁₀-C₁₆ soaps may be used.

Other anionic surfactants useful for detersive purposes can also be included in the liquid compositions hereof. These can include C₈-C₂₂ primary or secondary alkanesulphonates, C₈-C₂₄ olefinsulphonates, sulphonated polycarboxylic acids, alkyl glycerol sulphonates, fatty acyl glycerol sulphonates, fatty oleyl glycerol sulphates, alkyl phenol ethylene oxide ether sulphates, paraffin sulphonates, alkyl phosphates, isothionates such as the acyl isothionates, N-acyl taurates, fatty acid amides of methyl tauride, alkyl succinamates and sulphosuccinates, monoesters of sulphosuccinate (especially saturated and unsaturated C₁₂-Cl₈ monoesters) diesters of sulphosuccinate (especially saturated and unsaturated C₆-C₁₄ diesters), N-acyl sarcosinates, sulphates of alkylpolysaccharides such as the sulphates of alkylpolyglucbside, branched primary alkyl sulphates, alkyl polyethoxy carboxylates such as those of the formula RO(CH₂CH₂0)ₖCH₂COO-M+wherein R is a C₈-C₂₂ alkyl, k is an integer from 0 to 10, and M is a soluble salt-forming cation, and fatty acids esterified with isethionic acid and neutralised with sodium hydroxide. Further examples are given in Surface Active Agents and Detergents (Vol. I and II by Schwartz, Perry and Berch).

Alkyl alkoxylated sulphate surfactants are another category of preferred anionic surfactant. These surfactants; are water soluble salts or acids typically of the formula RO(A)mSO₃M wherein R is an unsubstituted C₁₀-C₂₄ alkyl or hydroxyalkyl group having a C₁₀-C₂₄ alkyl component, preferably a C₁₂-C₂₀ alkyl or hydroxyalkyl, more preferably C₁₂-C₁₈ alkyl or hydroxyalkyl, A is an ethoxy or propoxy unit, m is greater than zero, typically between about 0.5 and about 6, more preferably between about 0.5 and about 3, and M is hydrogen or a water soluble cation which can be, for example, a metal cation (e.g., sodium, potassium, lithium, calcium, magnesium, etc.), ammonium or substituted-ammonium cation. Alkyl ethoxylated sulphates as well as alkyl propoxylated sulphates are contemplated herein. Specific examples of substituted ammonium cations include methyl-, dimethyl-, trimethyl-ammonium and quaternary ammonium cations, such as tetramethyl-ammonium, dimethyl piperdinium and cations derived from alkanolamines, e.g., monoethanolamine, diethanolamine, and triethanolamine, and mixtures thereof. Exemplary surfactants are C₁₂-C₁₈ alkyl polyethoxylate (1.0) sulphate, C₁₂-C₁₈ alkyl polyethoxylate (2.25) sulphate, CL₂-C₁₈ alkyl polyethoxylate (3.0) sulphate, and C₁₂-C₁₈ alkyl polyethoxylate (4.0) sulphate wherein M is conveniently selected from sodium and potassium.

The liquid detergent compositions of the present invention preferably comprise at least about 5%, preferably at least 10%, more preferably at least 12% and less than 70%, more preferably less than 60% by weight, of an anionic surfactant.

Preferred nonionic surfactants such as C12-C18 alkyl ethoxylates (“AE”) including the so-called narrow peaked alkyl ethoxylates and C₆-C₁₂ alkyl phenol alkoxylates (especially ethoxylates and mixed ethoxy/propoxy), block alkylene oxide condensate of C₆ to C₁₂ alkyl phenols, alkylene oxide condensates of C₈-C₂₂ alkanols and ethylene oxide/propylene oxide block polymers (Pluronic™-BASF Corp.), as well as semi polar nonionics (e.g., amine oxides and phosphine oxides) can be used in the present liquid compositions. An extensive disclosure of these types of surfactants is found in U.S. Pat. No. 3,929,678.

Alkylpolysaccharides such as disclosed in U.S. Pat. No. 4,565,647 are also preferred nonionic surfactants in the liquid compositions of the invention. Further preferred nonionic surfactants are the polyhydroxy fatty acid amides. A particularly desirable surfactant of this type for use in the liquid compositions herein is alkyl-N-methyl glucamide.

Other sugar-derived surfactants include the N-alkoxy polyhydroxy fatty acid amides, such as C₁₀-C₁₈ N-(3-methoxypropyl) glucamide. The N-propyl through N-hexyl C₁₂-C₁₈ glucamides can be used for low sudsing. C₁₀-C₂₀ conventional soaps may also be used. If high sudsing is desired, the branched-chain C₁₀-C₁₆ soaps may be used.

The liquid detergent compositions of the present invention preferably comprise at least about 5%, preferably at least 10%, more preferably at least 12% and less than 70%, more preferably less than 60% by weight, of a nonionic surfactant.

Carriers

Liquid detergent compositions of the invention may contain various solvents as carriers. Low molecular weight primary or secondary alcohols exemplified by methanol, ethanol, propanol, and isopropanol are suitable. Other suitable carrier materials are glycols, such as mono-, di-, tri-propylene glycol, glycerol and polyethylene glycols (PEG) having a molecular weight of from 200 to 5000.

The compositions may contain from 1% to 50%, typically 5% to 30%, preferably from 2% to 10%, by weight of such carriers.

Detergency Builders

One or more detergency builders may be suitably present in the liquid detergent composition of the invention.

Examples of suitable organic detergency builders, when present, include the alkaline metal, ammonium and substituted ammonium polyacetates, carboxylates, polycarboxylates, polyacetyl carboxylates, carboxymethyloxysuccinates, carboxymethyloxymalonates, ethylene diamine-N,N-disuccinic acid salts, polyeppxysuccinates, oxydiacetates, triethylene tetramine hexa-acetic acid salts, N-alkyl imino diacetates or dipropionates, alpha sulpho- fatty acid salts, dipicolinic acid salts, oxidised polysaccharides, polyhydroxysulphonates and mixtures thereof.

Specific examples include sodium, potassium, lithium, ammonium and substituted ammonium salts of ethylenediamino-tetraacetic acid, nitrilo-triacetic acid, oxydisuccinic acid, melitic acid, benzene polycarboxylic acids and citric acid, tartrate mono succinate and tartrate di succinate.

Other Optional Ingredients

The compositions herein can further comprise a variety of optional ingredients. A wide variety of other ingredients useful in detergent compositions can be included in the compositions herein, including other active ingredients, hydrotropes, processing aids, dyes or pigments, solid fillers for bar compositions, etc.

If high sudsing is desired, suds boosters such as the C₁₀-C₁₆ alkanolamides can be incorporated into the compositions, typically at 1%-10% levels. The C10-C₁₄ monoethanol and diethanol amides illustrate a typical class of such suds boosters. If desired, soluble magnesium salts such as MgCl₂, MgS0₄, and the like, can be added at levels of, typically, 0.1%-2%, to provide additional suds and to enhance grease removal performance.

Chelating Agents

The liquid detergent compositions herein may also optionally contain one or more iron, copper and/or manganese chelating agents. Such chelating agents can be selected from the group consisting of amino carboxylates, amino phosphonates, polyfunctionally-substituted aromatic chelating agents and mixtures therein, all as hereinafter defined.

If utilised, these chelating agents will generally comprise from about 0.1% to about 10% by weight of the detergent compositions herein. More preferably, if utilised the chelating agents will comprise from about 0.1% to about 3.0% by weight of such compositions.

Suitable types of phosphonates for use as chelating agents in the composition of the invention are ethylene diamine tetramethylene phosphonate and diethylene triamine pentamethylene phosphonate.

Suitable examples of carboxylates for use as chelating agents are ethylene diamine disuccinate (EDDS), ethylene diamine tetraacetate (EDTA), diethylene triamine pentaacetic acid (DTPA), and imino disuccinic acid (IDS).

Clay Soil Removal/Anti-Redeposition Agents

The compositions of the present invention can also optionally contain water-soluble ethoxylated amines having clay soil removal and antiredeposition properties.

Liquid detergent compositions typically contain 0.0 1% to 5% of these agents.

One preferred soil release and anti-redeposition agent is ethoxylated tetraethylenepentamine. Exemplary ethoxylated amines are further described in U.S. Pat. No. 4,597,898, Other types of preferred antiredeposition agent include the carboxy methyl cellulose (CMC) materials. These materials are well known in the art.

Brightener

Any optical brighteners or other brightening or whitening agents known in the art may be incorporated at levels typically from about 0.05% to about 1.2%, by weight, into the liquid detergent compositions herein. Commercial optical brighteners which may be useful in the present invention can be classified into subgroups, which include, but are not necessarily limited to, derivatives of stilbene, pyrazoline, cournarin, carboxylic acid, methinecyanines, dibenzothiphene-5,5-dioxide, azoles, 5- and 6-membered-ring heterocycles, and other miscellaneous agents. Examples of such brighteners are disclosed in “The Production and Application of Fluorescent Brightening Agents”, M. Zahradnik, Published by John Wiley & Sons, New York (1982).

Suds Suppressors

Compounds for reducing or suppressing the formation of suds can be incorporated into the compositions of the present invention. Suds suppression can be of particular importance in the so-called “high concentration cleaning process” as described in U.S. Pat. Nos. 4,489,455 and 4,489,574 and in front-loading European-style washing machines.

A wide variety of materials may be used as suds suppressors, and suds suppressors are well known to those skilled in the art. See, for example, Kirk Othmer Encyclopedia of Chemical Technology, Third Edition, Volume 7, pages 430-447 (John Wiley & Sons, Inc., 1979). One category of suds suppressor of particular interest encompasses monocarboxylic fatty acid and soluble salts therein. See U.S. Pat. No. 2,954,347. The monocarboxylic fatty acids and salts thereof used as suds suppressor typically have hydrocarbyl chains of 10 to about 24 carbon atoms, preferably 12 to 18 carbon atoms. Suitable salts include the alkali metal salts such as sodium, potassium, and lithium salts, and ammonium and alkanolammonium salts.

The detergent compositions herein may also contain non-surfactant suds suppressors. These include, for example: high molecular weight hydrocarbons such as paraffin, fatty acid esters (e.g., fatty acid triglycerides), fatty acid esters of monovalent alcohols, aliphatic C 1 8-C40 ketones (e.g., stearone), etc.

Fabric Softeners

Various through-the-wash fabric softeners, especially the impalpable smectite clays of U.S. Pat. No. 4,062,647 as well as other softener clays known in the art, can optionally be used typically at levels of from about 0.5% to about 10% by weight in the present compositions to provide fabric softener benefits concurrently with fabric cleaning. Clay softeners can be used in combination with amine and cationic softeners as disclosed, for example, in U.S. Pat. No. 4,375,416 and U.S. Pat. No. 4,291,071.

Dye Transfer Inhibiting Agents

The compositions of the present invention may also include one or more materials effective for inhibiting the transfer of dyes from one fabric to another during the cleaning process. Generally, such dye transfer inhibiting agents include polyvinyl pyrrolidone polymers, polyamine N-oxide polymers, copolymers of N-vinylpyrrolidone and N-vinylimidazole, manganese phthalocyanine, peroxidases, and mixtures thereof. If used, these agents typically comprise from about 0.01% to about 10% by weight of the composition, preferably from about 0.01% to about 5%, and more preferably from about 0.05% to about 2%.

When the composition is in the form of a liquid, segregation of various components may be necessary. One form of segregation that is preferred is that of coacervation. The use of pH-Jump compositions and antioxidants are also applicable to preserving the integrity of certain components within the composition.

Since many bleaches and bleach systems are unstable in aqueous liquid detergents and/or interact unfavourably with other components in the composition, e.g. enzymes, they may for example be protected, e.g. by encapsulation or by formulating a structured liquid composition, whereby they are suspended in solid form.

The invention will now be illustrated by way of the following non-limiting examples, in which all parts and percentages are by weight unless otherwise indicated.

### EXAMPLE 1

The following liquid detergent formulations were prepared:

| | Example no. | | | | |
|---|---|---|---|---|---|
| | 1A | 1B | 1C | 1D | 1E |
| Ingredient | (% wt) | (% wt) | (% wt) | (% wt) | (% wt) |
| LAS acid | 6 | 6 | 6 | 6 | 6 |
| sLES (3EO) | 6 | 6 | 6 | 6 | 6 |
| NI 9EO | 6 | 6 | 6 | 6 | 6 |
| Prifac 7908 | 1 | 1 | 1 | 1 | 1 |
| Bleach catalyst | 0.03 | 0.03 | 0.03 | 0.03 | 0.03 |
| Na₂-tetraborate.10H₂O | 3.0 | 0 | 0 | 0 | 0 |
| Boric acid | 0 | 1.95 | 0 | 0 | 0 |
| Na-metaborate | 0 | 0 | 4.35 | 0 | 0 |
| Na₂-tetraborate.5H₂O | 0 | 0 | 0 | 2.28 | 0 |

| | |
|---|---|
| Water | balance to 100% |

Wherein:
LAS-acid = C₁₀-C₁₄ alkyl benzene sulphonic acid,
sLES (3EO) = sodium lauryl ether sulphate (with on average 3 ethylene oxide groups),
NI 9EO = C₁₂-C₁₃ fatty alchocol ethoxylated with on average 9 ethylene oxide groups,
Prifac 7908 = unsaturated type of palm kernel fatty acid having iodine value of 16-21,
Bleach catalyst = 3-methyl-7-(pyridin-2-ylmethyl)-3,7-diazabiocyclo[3.3.1]nonan-9-one-1,5-dicarboxylate) iron(II)-chloride hydrate.

More information about the bleach catalyst in these formulations can-be found in WO-02/48301. It is also noted that these formulations have a pH-value of 7.

Furthermore, liquid detergent formulations similar to each of the above formulations of examples 1A-1E were prepared, the only difference with the above formulations being that 0.016% respectively 0.008% BHT were added.

In this example, the residual activity of the bleach catalyst in all above-mentioned liquid detergent formulations after 4 weeks of storage at 37° C. was determined. For this determination, the bleach catalyst activity was measured at 40° C. in a H₂O₂-containing NaH₂PO₄.H₂O pH7-buffer and using Acid Blue (CAS-no. 2861-02-1) as substrate.

More particularly, the following protocol was used:

Samples of 70 mg of the tested liquid formulation was diluted in 10 ml MilliQ water. 10 μl of this solution was added to an assay of 230 μl containing 20 mMol H2O2, 75 μMol Acid Blue 45 and 54 mMol NaH₂PO₄.H₂O pH7-buffer.

The absorbance of the tested samples at a wavelength of 450 nm was measured for 15 minutes at 40° C. using a spectrophotometer. The absolute changes in absorbance as compared to the absorbance measured on the freshly prepared calibration sample were correlated to the measured activity of such freshly prepared sample. The measured bleach catalyst activities were expressed as μMol/l.

The residual bleach catalyst activity (expressed as %) is the bleach catalyst activity after 4 weeks of storage (at 37° C.) of the tested liquid detergent formulation concerned divided by the bleach catalyst activity of that formulation at t=0.

Table 1 shows the residual bleach catalyst activities in the various liquid compositions as described above.

TABLE 1

| | Example no. | | | | |
|---|---|---|---|---|---|
| Added material | 1A | 1B | 1C | 1D | 1E |
| None | 30 | 39 | 22 | 31 | 93 |
| 0.016% Proxel GXL | 58 | 69 | 50 | 56 | 97 |
| 0.008% BHT | 84 | 81 | 62 | 80 | 97 |

When considering these results, it can be clearly noticed that the residual bleach catalyst activity in the formulations containing one of the antioxidants Proxel GXL or BHT is significantly higher than in the formulations not containing these added materials. It can also be derived from the results shown in Table 1 that boron-containing compounds have a negative influence on the residual bleach catalyst activity: the formulations of Example 1E which are free of boron-containing compounds clearly show the highest residual bleach-catalyst activity.

### EXAMPLE 2

The following liquid detergent formulations were prepared:

| | Example no. | | |
|---|---|---|---|
| | 2A | 2B | 2C |
| Ingredient | (% wt) | (% wt) | (% wt) |
| SLES (3EO) | 9 | 9 | 9 |
| NI 9EO | 9 | 9 | 9 |
| BHT | 0 | 0 | 0.16 |
| Proxel GXL | 0 | 0.016 | 0 |
| Prifac 5908 | 1.25 | 1.25 | 1.25 |
| Na-citrate | 2 | 2 | 2 |
| Bleach Catalyst | 0.03 | 0.03 | 0.03 |

| | |
|---|---|
| Water | balance to 100% |

The above liquid detergent formulations of Examples 2A-2C had a pH-value of 8. The residual activity of the bleach catalyst present in these liquid formulations after 4 weeks of storage at 37° C. was determined using the protocol described in example 1.

Table 2 shows the residual bleach catalyst activities in these liquid compositions.

TABLE 2

| | 2A | 2B | 2C |
|---|---|---|---|
| Residual activity | 9 | 49 | 36 |

It can be derived from these results that considerably increased residual bleach catalyst activities could be obtained when applying BHT or Proxel GXL.

1. An aqueous liquid bleaching detergent composition, comprising:
(a) a bleach catalyst being an organic substance which forms a complex with a transition metal for bleaching a substrate with atmospheric oxygen, the liquid bleaching composition upon addition to an aqueous medium providing a diluted bleaching medium substantially devoid of a peroxygen bleach or a peroxy-based or peroxyl-generating bleach system; and
(b) from 0.001 to 0.1% by weight of an anti-oxidant; said composition being substantially free of boron and of perfume.

2. A liquid bleaching composition according to claim 1, comprising from 0.002 to less than 0.08% by weight of the anti-oxidant.

3. A composition according to claim 1, wherein the composition further comprises a fatty acid soap having an iodine value lower than 1.0, preferably lower than 0.3.

4. A liquid composition according to claim 1, further comprising an effective amount of an enzyme.

5. A liquid composition according to claim 4, wherein the enzyme is selected from the group consisting of a proteolytic enzyme, an amylolytic enzyme, a lipolytic enzyme, a cellulolytic enzyme and mixtures thereof.

6. A liquid composition according to claim 1, wherein the antioxidant is selected from 2,6-di-tert-butyl-hydroxy-toluene (BHT), alpha-tocopherol, ethoxyquine, 2,2,4-trimethyl-1,2-dihydroquinoline, 2,6-di-tert-butyl-hydroquinone, tert-butyl-hydroxy anisole, lignosulphonic acid, 6-hydroxy-2,5,7,8-tetra-methylchroman-2-carboxylic acid (Trolox™), 1,2-benzisothiazoline-3-one (Proxel GXL™) and salts thereof, and mixtures thereof.

7. A liquid composition according to claim 6, wherein the antioxidant is selected from 2,6-di-tert-butyl-hydroxy-toluene (BHT), alpha-tocopherol, 1,2-benzisothiazoline-3-one (Proxel GXL™) and mixtures thereof.

8. A liquid composition according to claim 1, wherein the water content of said composition is in the range of from 30 to 80% by weight.

9. A method of bleaching a textile, comprising the steps of treating the textile with a liquid bleaching composition as defined in claim 1 in an aqueous environment, rinsing the textile and drying it.
